(19) United States
(12) Patent Application Publication
(10) Pub. No.: US 2016/0295838 A1
(43) Pub. Date: Oct. 13, 2016

(54) METHOD AND DEVICE TO MONITOR GROWTH OF AN ANIMAL, IN PARTICULAR A CALF

(71) Applicant: LELY PATENT N.V., Maassluis (NL)

(72) Inventors: Adolf Jan VAN DER KAMP, Maassluis (NL); Patrick Philip Jacob VAN DER TOL, Maassluis (NL)

(73) Assignee: Lely Patent N.V., Maassluis (NL)

(21) Appl. No.: 15/100,459

(22) PCT Filed: Nov. 14, 2014
(86) PCT No.: PCT/NL2014/050783

§ 371 Date: May 31, 2016

(30) Foreign Application Priority Data
Dec. 12, 2013 (NL) 2011952

(51) Int. Cl. A01K 29/00; H04N 7/18; H04N 13/02; G06T 7/60

(52) U.S. Cl. CPC A01K 29/005; G06T 7/602; H04N 7/183; H04N 13/0203; G06T 2207/10028

(57) ABSTRACT

The invention relates to a method to monitor growth of an animal, in particular a calf, the method including recording, by a three-dimensional camera system, at least one three-dimensional image of the animal, and processing, by a processing device, the at least one image of the animal, wherein processing of the image comprises the steps of: forming a three-dimensional surface representation of a surface part of the animal from the at least one image, determining a size parameter representative for the size of the animal on the basis of the surface representation, and determining a volume parameter representative for the volume of the animal, and monitoring the volume parameter and size parameter or a combination thereof to monitor growth of the animal.

The invention relates to a method and device to monitor growth of an animal, in particular a calf, using three dimensional images of the animal.

Calf growth is one of the most important indicators of the young animal health in early stage.

In a known method, the front body weight of a calf is measured by a scale as a main parameter representative for growth of a calf. However, this parameter based on front body weight does not always represent the growth of the calf sufficiently accurate which may lead to misinterpretation of the health status and growth of the calf.

It is an aim of the present invention to provide an improved method to monitor the growth of an animal, in particular a young animal, such as a calf.

The present invention provides a method according to claim 1.

According to the method of the invention, the growth of an animal is monitored by recording, by a three-dimensional camera system, at least one three-dimensional image of the animal, and processing, by a processing device, the at least one image of the animal.

The processing of the image comprises the steps of forming a three-dimensional surface representation of a surface part of the animal from the at least one image, determining a size parameter representative for the size of the animal on the basis of the surface representation, and determining a volume parameter representative for the volume of the animal, and monitoring the volume parameter and size parameter or a combination thereof to monitor growth of the animal. Herein as for all parameters to be used in the present invention, “determining a parameter” generally includes determining a value of that parameter, it does not strictly relate to determining a type of parameter, or selecting a parameter from a number of parameters.

The size parameter is related to the size of the animal, i.e. a value on the basis of which a development in the size of the animal can be monitored. In this patent application the term size is typically used to describe dimensions of at least a part of the skeleton of the animal.

The volume parameter is related to the volume of the animal, i.e. a value on the basis of which a development in the volume of the animal can be monitored. In this patent application, the term volume is used to describe the volume of the animal or a part thereof.

The size parameter and volume parameter are representative for size and volume respectively, but do not have to be estimates of these quantities. Also, the size parameter and volume parameter do not have to be necessarily values expressed in m and m³. For example, the body weight of the animal may be used as a volume parameter, but also all volume between a reference surface, such as a floor surface, and a back surface part of the animal may be used as a volume parameter.

To monitor the growth of an animal in the course of time, it is advantageous to determine the size parameter and the volume parameter periodically, for example daily, weekly, bi-weekly or monthly. The intervals between consecutive measurements do not have to be the same. These intervals may for example be dependent on the presence of the animal at a location where the camera system is arranged.

The determined size parameter, volume parameter or a combination thereof may be compared with reference data related to the animal. The reference data may be dependent on type of animal, age, breed, etc.

In an embodiment, the step of determining a size parameter comprises determining a number of size reference points in the three-dimensional surface representation and determining the size parameter on the basis of one or more distances between the size reference points and/or the height of these size reference points.

Size reference points are points that can reliably be found in the three dimensional surface representation of the animal. The size reference points are typically characteristic points of the bone structure that are close to the skin of the animal, such that these characteristic points can be recognized in the image, and easily derived therefrom by image processing. Distances between these points can be determined as a parameter representative for size of the animal.

In an embodiment, the size reference points comprise characteristic points of a single bone of the animal, in particular the hip bone of an animal. The advantage of using a single bone of the animal to determine the size parameter is that the effect of different postures of the animal is avoided since the single bone part will have the same shape in every posture. For example, the length of the spine, when defined as a distance between two vertebrae may change due to different postures of the animal. When using a single bone part, this effect does not occur, or is at least minimized.

The hip bone (os coxae) is a relative large bone of an animal, such as a calf, and comprises characteristic points that can reliably be determined in a three dimensional image. The size reference points on the hip bone typically include hook bone points and pin bone points. When using hook bone points and pin bone points as size reference points, the size parameter may for instance be based on a distance between the pin bone points, also indicated as length of pin line, a distance between the hook bone points, also indicated as length of hip line, and/or a distance between the pin line and hip line, or any combination thereof

In addition, or as an alternative, the size parameter can be determined on the basis of a height level of the surface representation of the surface part.

This height level can be any height related parameter of the animal, and may be an absolute height, determined from stable floor or a relative height, i.e. a height with respect to a selected horizontal plane. The height level can be determined as the height of one or more size reference points of the animal, or a combination thereof, but may also be determined as the summed absolute or relative heights of a plurality of points within the surface part, for example all z vertical values of all image points within the surface part.

In an embodiment, the method comprises the step of measuring a body weight of the animal, and determining the volume parameter on the basis of the measured body weight. The body weight may be determined as the complete weight of the animal, but also as a partial weight, for instance the front body weight.

In an embodiment, the volume parameter may be the body weight itself. In such step the volume parameter is determined directly by measuring the complete or partial weight of the animal. In other embodiments, the body weight may be used to calculate the weight parameter. For instance the body weight may be rescaled or combined with other parameters.

In an embodiment, the volume parameter is determined as:

V=A+B*BW,

wherein V is the volume parameter, BW is measured body weight and A and B are predetermined constants.

The predetermined constants may be estimated predetermined constants that can be based on historical data. The constants may for example be obtained by curve fitting on previously obtained verified data. The constants may be dependent on other variables, such as age, breed, etc.

In an embodiment, the method comprises the step of determining a height parameter of the animal representative of a height level of the animal in the surface part, and determining the volume parameter on the basis of the height parameter. The height level can be representative for the size of the animal, but also for the volume of the animal, dependent on the selected points.

In an embodiment, the height parameter is determined as the sum of the height of one or more points in the surface representation of the surface part. Preferably, the height parameter is determined by summing up all pixel points within a surface part of the animal. A suitable surface part is the trapezoidal area delimited by hook bone points and pin bone points or an area extending from the spine line, for instance 20 centimeters at both sides and between pin line and hip line of the animal.

In an embodiment, the volume parameter is determined as:

V=A+B*BW+C*H,

wherein V is the volume parameter, BW is measured body weight, H is the summed height and A, B and C are predetermined constants.

The predetermined constants may be estimated predetermined constants that can be based on historical data. The constants may for example be obtained by curve fitting on previously obtained verified data. The constants may be dependent on other variables, such as age, breed, etc.

The volume parameter may be based on a combination of body weight and height level of the animal, for instance a height level of an upper surface of the animal. The height level of the upper surface of the animal may be used to estimate a volume of the animal below the upper surface.

In an embodiment, the surface part is defined as the trapezoidal surface part of the animal delimited by hook bone points and pin bone points.

In an embodiment, the step of monitoring the volume parameter and size parameter to monitor growth of the animal comprises determining whether the volume parameter and size parameter or a combination thereof is between a lower limit and an upper limit.

Generally, it is desirable that the growth of an animal in size, volume or a combination thereof remains between a lower limit and an upper limit, wherein the lower and upper limits are dependent on the age of the animal. The lower and upper limits may for example be based on a percentage or value below and above an average value of the monitored parameter.

The lower and upper limits will normally be predetermined and based on historical data. The lower and upper limits are dependent on age, and may further be dependent on type of animal, breed, etc. Other criteria, such as relative change of values of the monitored parameter or parameter combination in subsequent determinations of the same animal, or combinations of criteria, may also be used in monitoring of the growth of the animal.

The growth of the animal may be monitored by monitoring the volume parameter and/or volume parameter, but also on other combined parameters such as the ratio between size parameter and volume parameter.

The value of the monitored parameter can be used to provide a signal. This signal may be a signal for an animal related action and/or an alarm signal. The animal related action may for example include that a feeding device provides extra or less animal feed to the animal, or feed of a different composition, or a weaning related action, or the like. The method may thus also include performing that animal related action, on the basis of the value of the monitored parameter.

For example, the method may comprise the step of providing an alarm signal when the volume parameter and size parameter or a combination thereof is below the lower limit or above the upper limit.

In an embodiment, the step of forming a three-dimensional surface representation of a part of the animal from the three-dimensional image recorded by the three-dimensional camera system comprises one or more of the steps:
rotating the image based on the relative position of the camera system with respect to the animal;
removing background and noise in the image;
performing interpolation in the image; and/or
centralizing the image, for example by determining, in the image, a spine line of the animal, and translating and rotating the image to align the spine line with a central image axis.

The invention further relates to a monitoring device to monitor growth of an animal, in particular a calf, comprising:

a three-dimensional camera system configured to record at least one three-dimensional image of the animal, and

a processing device configured to process the image of the animal, said processing comprises the steps of:

forming a three-dimensional surface representation of a surface part of the animal from the three-dimensional image recorded by the three-dimensional camera system,

determining a size parameter representative for the size of the animal on the basis of the surface representation, and

determining a volume parameter representative for the volume of the animal, and

monitoring the volume parameter and size parameter to monitor growth of the animal.

The monitoring device may be provided in an arrangement having a location to receive an animal, such as a feeding location having a feeding device.

The monitoring device may further be configured to carry out one or more of the method steps described above.

It is remarked that in an alternative embodiment of a method to monitor growth of an animal, in particular a calf, the method comprises:

recording, by a three-dimensional camera system, at least one three-dimensional image of the animal, and

processing, by a processing device, the at least one image of the animal,

wherein processing of the image comprises the steps of:

forming a three-dimensional surface representation of a surface part of the animal from the at least one image,

determining a size parameter representative for the size of the animal on the basis of the surface representation,

monitoring the size parameter to monitor growth of the animal.

In such embodiment growth of the size of the animal can be determined without using a volume parameter.

Embodiments of a method and arrangement according to the invention will now be described in further detail, by way of example only, with reference to the accompanying drawings, in which:

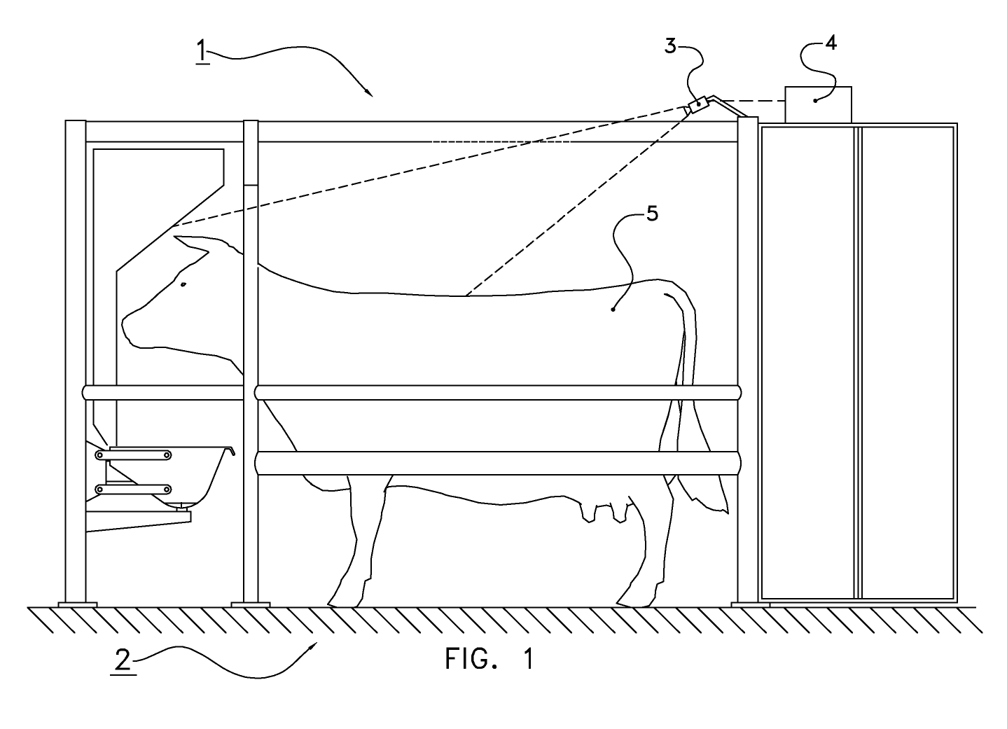

FIG. 1 shows an embodiment of an arrangement according to the invention;

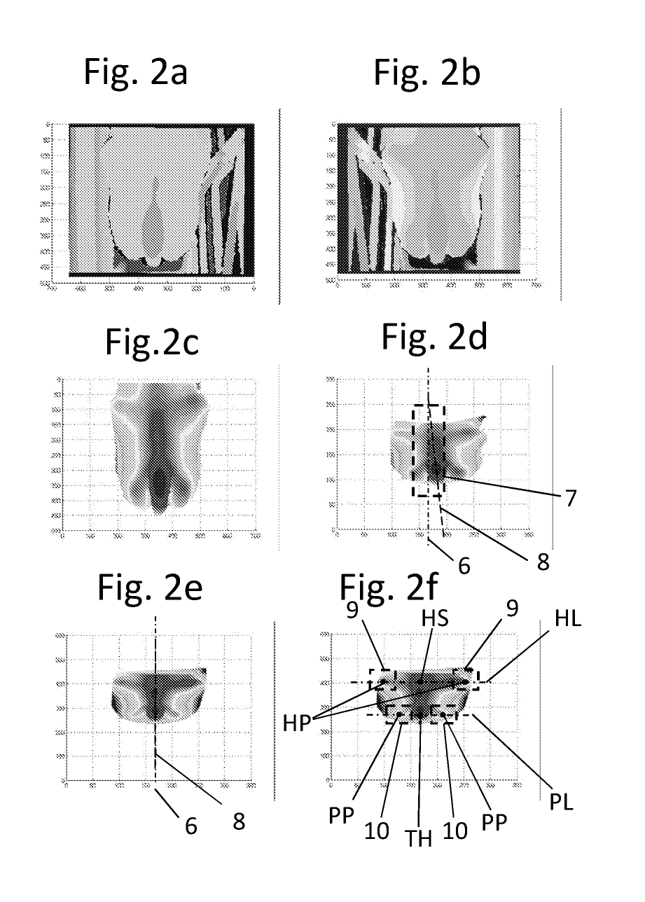

FIGS. 2a-2f show results of subsequent steps of processing a three-dimensional image and determination of reference points; and

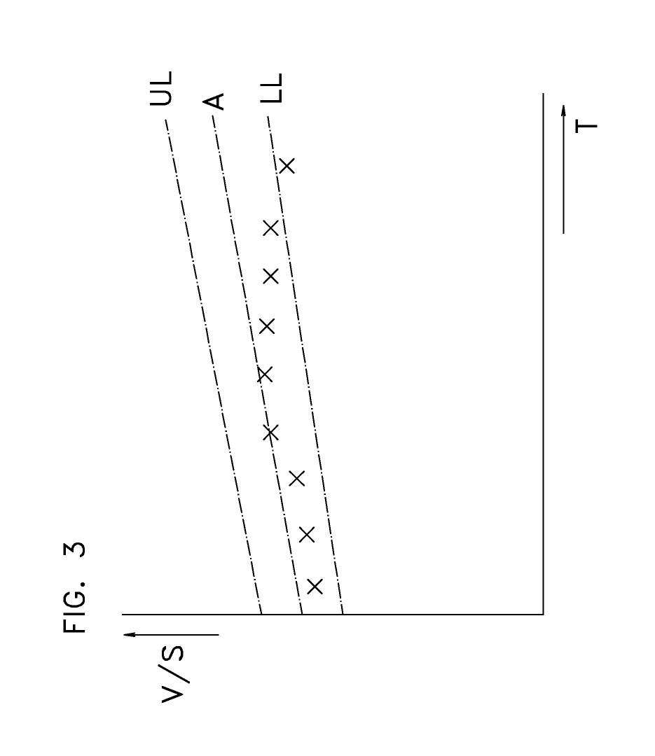

FIG. 3 shows comparison of a combination of volume parameter and size parameter with reference values to monitor growth.

FIG. 1 shows an arrangement 1 configured to monitor growth of an animal 5, for example a calf or other young animal. The arrangement 1 is provided in a location 2 defined by fences to limit movement of the animal 5. The location 2 is provided with a feeding device to feed the animal, but may also be provided with other devices. An example of such a feeding station is the Lely Calm®.

The arrangement 1 comprises a three-dimensional camera system 3 configured and arranged to record at least one three-dimensional image of the animal, and an image processing device 4 to process the image. Such three-dimensional camera system 3 may comprise any suitable three dimensional camera such as an ASUS Xtion Pro Live (depth) having a resolution 640*480 and taking images at a rate of 30 frames per second.

The camera system 3 may be provided for example about 1.65 m above floor level, for measurements on calves of dairy animals, or for example at least 2 m, for example 2.2 meters, above floor level at a camera angle of less than 10 degrees, for example 2 degrees facing down towards the animal arranged in the location 2 in case of a dairy animal.

The processing device 4 may be any suitable device for processing the three dimensional images taken by the three-dimensional camera system 3, and may be a separate device or integrated in the three-dimensional camera system 3. The processing device 4 may also be integrated in a central processing device, for example a central computer device configured to monitor a number of animals, such as a herd management system, and/or configured to monitor and control one or more automatic feeding devices.

The camera system 3 is connected to the processing device 4 to transfer images taken by the camera system 3 to the processing device 4.

The camera system 3 and the processing device 4 are part of a monitoring device configured to monitor growth of the animal 5. The arrangement may also comprise an animal identification system in order to assign a recorded image and other animal related data, such as size parameter and volume parameter to the stored data of the respective animal 5.

The camera system 3 is configured to periodically, for example daily or weekly record an image of the respective animal 5. The periods may be fixed, but in practice the periods between two consecutive images may differ as long as sufficient images are recorded to monitor growth of the animal 5. For example the time between two consecutive images may depend on the visits of the animal of the location 2. The period between two images may also be dependent on variables such as the age of the animal, the growth history of the animal and the current health of the animal.

By processing of an image, or multiple images, at least a size parameter representative of the size of the animal can be deducted. Furthermore, in some embodiments, the image may also be used to determine a volume parameter representative of the volume of the animal. However, the volume parameter may also be determined in other ways.

The processing device 4 is configured to process the image. Processing of the image involves a number of steps to process the image from coarse image data as obtained by the camera system 3 to a three-dimensional surface representation of at least part of the animal 5 that can be used to monitor the growth of the animal 5.

As a first step, shown in FIG. 2a, the coarse image data obtained by the three-dimensional camera system 3, usually comprising distance data from camera to animal, is transformed to data in an orthogonal coordinate system. As a next step, the image is three dimensionally rotated to compensate the camera angle with respect to the animal. Furthermore, the height values of FIG. 2a, which represent a distance to the camera, have each been subtracted from the camera height, so that the resulting values represent the (real) height above the floor. FIG. 2b shows the image data after rotation for compensation of the camera angle and subtraction from camera height. The image is furthermore mirrored, as can be seen in the horizontal axis.

Then, noise and background in the image may be removed. Noise can be removed by known filtering techniques. Furthermore, it is known that some fixed objects such as fences may be present in the image. It is advantageous to filter out this background as this may influence the results in later steps of the method. FIG. 2c shows the processed image after filtering out noise and background features.

As a result of the first image processing steps the image points may have a coarse distribution in some areas of the image and/or have a very fine distribution in other areas of the image. For further processing of the image, it is desirable to have a relatively even and fine distribution of image points over the image. To obtain such even and fine distribution of image point over the whole images, new points may be defined by interpolation between surrounding image points. In this way, an even distribution with an accuracy of for example 2 to 5 mm, such as 3 mm, may be obtained. It may be possible to recalculate the points to an even distributed matrix of image points having rows and columns with a constant pitch of for example 3 mm. FIG. 2d shows the image after interpolation of the image.

Finally, the image is centralized at a predetermined central image axis 6 (shown in FIGS. 2d and 2e). To properly define relevant surface parts of the image, it is desirable that the image is arranged at a suitable angle with respect to the image axes, i.e. the axes of the coordinate system in which the image is defined. In particular, it is desirable to align the spine line 8, i.e. the longitudinal axis of the spinal ridge, with a central image axis 6 of the coordinate system in which the image is defined.

This centralizing step can be performed by determining, in the image, a spine line 8 of the animal, and translating and rotating the image to align the spine line with the central image axis 6 (compare FIGS. 2d and 2e). Since the coarse position of the animal 5 in the image is known, the spine line 8 can be found by finding the highest points of the image in an area 7 of the image where the spine is expected, and defining the spine line as a straight line through the highest points in this area 7.

The area 7 can for example be defined as an area extending equally at opposite sides of the central image axis 6 as shown in FIG. 2d, but can also be determined on the basis of coarse image data, for example by calculating an area having a relative large number of high points in the image.

In an embodiment, the spine line can be coarsely estimated by summing all points in length direction of the animal 5, resulting in a height profile in width direction of the animal 5, and defining a coarse spine line at the highest point of the height profile. Subsequently, the spine line can be determined more accurately by finding the highest point in an area extending at both sides of the coarse spine line, such as area 7.

The processing of the image may further comprise normalization of the image to make a better comparison of different images of the same animal or, in some cases, between results of different animals.

When processing of the image has been finished, size reference points, in particular hook bone points HP and pin bones points PP may be localized in the image, as shown in FIG. 2f. To localize hook bone points HP and pin bones points PP the following method is used.

As the position of the hook bone points HP and pin bone points PP can coarsely predicted from the image data and the general anatomy of the animal 5, local areas 9, 10 can be defined of the image in which a location of the respective size reference points is expected.

For example, to coarsely predict the location of the hook bone points HP and the pin bone points PP, all points are summed in the width direction to obtain a height profile in the length direction. On the basis of the height profile in length direction the hip line HL comprising the hook bone points HP and the pin line PL comprising the pin bone points PP can be determined. The hip line HL and the pin line PL are the highest lines in the subarea where these hip and pin lines can be expected on the basis of the image data and general anatomy of the animal 5. Subsequently, the respective reference points can be determined by a specific characteristic of the reference point within a local area.

For example, the hook bone points HP can be determined by first defining a local area 9 on the basis of coarse image data and/or general anatomical data of the respective animal 5, for example stored in a database; and by subsequently determining the location of the hook bone points by finding a highest surface point within the local area 9.

Similarly, the location of the pin bone points PP can be found by defining a local area 10 on the basis of coarse image data and/or general anatomical data of the respective animal 5, for example stored in a database; and thereafter finding the pin bone points PP by a suitable characteristic of the pin bone points, in particular the highest point in within the local areas 10.

Further points such as a cross point HS between spine line 8 and hip line HL and a cross point TH between spine line 8 and pin line PL can be determined. In the shown embodiment, the cross points HS and TH are defined as the point hallway between the hook bone points HP and the pin bone points PP, respectively.

The (pre)processed image can be used to determine a size parameter of the animal. The size parameter is a parameter that is representative for size of the skeleton of the animal.

A first size parameter is based on the reference points and may comprise the distance between the hook bone points HP, the distance between the pin bone points PP, the distance between the hip line HL and the pin line PL, or any combination thereof.

Since the hook bone points HP and the pin bone points PP are characteristic points of a single bone part, i.e. the hip bone, the distance between these points is independent of the posture and volume of the animal 5. Therefore, the size parameter based on these points provides relevant information on the development of the skeleton size of the animal 5.

In addition, or as an alternative, a second size parameter can be determined. The second size parameter is based on the height of the animal 5. The height of the animal 5 with respect to a reference surface, for example the floor surface or another horizontal surface can be used to monitor the height of the animal 5.

In an advantageous embodiment, the size parameter is calculated as the summed height of all height levels of a plurality of predetermined pixel points in the trapezoidal surface part delimited by the hook bone points HP and pin bones points PP. For example, the height levels of the hook bone points HP, pin bones points PP and/or cross points HS and TH may be used. Any other combination of height levels of reference points may also be used. However, it is advantageous to use reference points of which the height is not or less influenced by the volume of the animal. In other words, the reference points to determine the height of the animal are preferably reference points at locations where characteristic bone parts are close to the skin of the animal.

A first volume parameter that can be used to monitor growth of the volume of the animal may be the partial or complete body weight of the animal. The partial or complete body weight may be obtained by using a weight measuring scale that can be arranged at the location 2. The measured body weight may directly be used as volume parameter, but also may be used to calculate a volume parameter. For example, the volume parameter may be determined by the equation V=A+B*BW, wherein V is the volume parameter, BW is measured body weight and A and B are predetermined constants that for instance may be based on historical data and variables such as breed and age of the animal.

In addition, or as an alternative, a second volume parameter may be based on a calculated volume below an upper surface of the animal. For example, the volume below the trapezoidal surface part formed by the hook bone points HP and pin bones points PP, may be used as a second volume parameter to monitor growth of an animal. In such embodiment the height parameter is determined as the sum of height levels of a plurality of pixel points in the trapezoidal surface part.

On the basis of the size parameter and the growth parameter and/or a combination thereof a determination of the growth of the animal can be made. This growth can be compared with reference values. For example, it may be determined whether the growth of the animal is within a certain range between an upper limit and a lower limit.

FIG. 3 shows an example of a diagram in which the development of a ratio between volume and size can be monitored over time. In the diagram of FIG. 3 the horizontal axis indicates age T and the vertical axis indicates the ratio V/H between volume of the animal and size of a specific animal. In the diagram three lines are shown, an average line A, an upper limit UL and a lower limit LL. The lines may be based on historical data and may be different for different types of animals, different breed, different growth conditions etc. The upper limit UL and the lower limit LL may for example be defined as a certain value or percentage above and below the average line A, but may also be determined in any other suitable way.

The average line A indicates the average development of the ratio V/H as the animal ages. As is clear from the diagram the average ratio V/H changes when the age of the animal increases.

The upper limit UL and the lower limit LL indicate a range in which the ratio V/H may vary without any action to be taken. However, when the ratio V/H of a specific monitored animal would come below the lower limit LL or above the upper limit UL action should be taken.

In FIG. 3, each determination of a ratio between a volume parameter and a size parameter is shown as an x. When the development in time of the ratio V/H of the animal 5 is followed, it can be seen that the ratio V/H is within the range of the upper limit UL and the lower limit LL for all determination except for the last one. The last x is below the lower limit LL meaning that for the age of the animal at the moment of determination, the ratio V/H is too low, which for example may indicate that the body weight of the animal is too low compared with the size of the animal.

In such case, the monitoring device is configured to provide a signal for an animal related action and/or an alarm signal. The animal related action may for example be that the calf is given automatically extra animal feed the next time the respective animal enters the feeding device. Also, the time interval with which the animal is monitored, may be adapted when the ratio V/H is outside the desired range. An alarm signal may also be provided. Such alarm signal may for example be a warning signal to a farmer to check the health status of the animal.

In an embodiment, the different signals may be associated with different upper and lower limits. For example, an animal related action may be taken when the deviation is more than 10% of the average line A, while the warning signal is given only after a deviation of more than 20% of the average line A. Instead of an upper limit UL and a lower limit LL also other reference data and reference criteria may be used. For example, it may be monitored that a change in a monitored parameter or parameter combination does not exceed 10% compared with the previous determined value.

FIG. 3 shows an example of a monitored ration V/H. In practice also other values may be monitored such as the volume parameter, the size parameter and/or another combination thereof. It may be advantageous to monitor simultaneously several parameters.

### Example of Monitoring of Animals

68 Holstein Friesian calves (age between one and twelve weeks) were selected at seven farms in the Netherlands in 2013. All animals were kept in group-housing systems and could freely visit an automatic calf feeding machine (CALM®, Lely Industries N.V., Maassluis, the Netherlands). A 3D Time of Flight (ToF) camera was placed above the feeding machine horizontally (1.6 meters high). Images combined with animal identifications were recorded for six weeks. Calf's body weight and height at hips were manually measured every week to serve as references.

Locations of hipbones, tail head, body volume, rump surface and average body height were determined from the 3D body surface image. 21 image variables were created as inputs of a forward stepwise selection procedure. Based on the output from this procedure, the four most relevant variables were selected to estimate calf BW by using a multiple linear regression model. Data from 49 calves were selected for training the model, the other 19 were used for validation.

As the result, the Root Mean Square Error (RMSE) of the weight estimation model was 4.26 kg with corresponding Standard Deviation (SD) of 5.30 kg (measured BWs ranged from 41 kg to 132.1 kg). The height measurements at hips had RMSEs of 2.78 cm (measured heights at hips ranged from 78 cm to 120 cm). Moreover, in weight estimations and distance measurements, there was no correlation between residuals of the prediction and references. In conclusion, it is feasible to apply the 3D vision technology to measure and monitor the calf growth automatically. These growth variables can offer not only animal health indications, but also information for future breeding selections.

1. A method to monitor growth of an animal, in particular a calf, comprising the steps:
recording, by a three-dimensional camera system, at least one three-dimensional image of the animal, and
processing, by a processing device, the at least one image of the animal,
wherein processing of the image comprises the steps of:
forming a three-dimensional surface representation of a surface part of the animal from the at least one image,
determining a size parameter representative for the size of the animal on the basis of the surface representation, and
determining a volume parameter representative for the volume of the animal, and
monitoring the volume parameter and size parameter or a combination thereof to monitor growth of the animal.

2. The method of claim 1, wherein the step of determining a size parameter comprises determining a number of size reference points in the three-dimensional surface representation and determining the size parameter on the basis of one or more distances between the size reference points and/or the height of these size reference points.

3. The method of claim 2, wherein the size reference points comprise characteristic points of a single bone of the animal, in particular the hip bone of an animal.

4. The method of claim 3, wherein the size reference points comprise hook bone points of the animal, pin bone points of the animal or a combination thereof.

5. The method of claim 1, wherein the method comprises the step of measuring a body weight of the animal, and determining the volume parameter on the basis of the measured body weight.

6. The method of claim 5, wherein the volume parameter is determined as:
V=A+B*BW,
wherein v is the volume parameter, BW is measured body weight and A and B are predetermined constants.

7. The method of claim 1, wherein the method comprises the step of determining a height parameter of the animal representative of a height level of the animal in the surface part, and determining the volume parameter on the basis of the height parameter.

8. The method of claim 7, wherein the height parameter is determined as the sum of height levels of a one or more points in the surface representation of the surface part.

9. The method of claim 5, wherein the volume parameter is determined as:
V=A+B*BW+C*H,
wherein V is the volume parameter, BW is measured body weight, H is the summed height and A, B and C are predetermined constants.

10. The method of claim 1, wherein the surface part is defined as the trapezoidal surface part delimited by hook bone points and pin bone points.

11. The method of claim 1, wherein monitoring the volume parameter and size parameter to monitor growth of the animal comprises comparing the volume parameter and size parameter or a combination thereof with reference data, for example determining whether the volume parameter and size parameter or a combination thereof is between a lower limit and an upper limit.

12. The method of claim 11, comprising the step of providing a signal for an animal related action and/or an alarm signal when the volume parameter and size parameter or a combination thereof is below the lower limit or above the upper limit, and/or providing the step of performing an animal related action on the basis of the volume parameter and size parameter or a combination thereof.

13. A monitoring device to monitor growth of an animal, in particular a calf, comprising:
a three-dimensional camera system configured to record at least one three-dimensional image of the animal,
a processing device configured to process the image of the animal, said processing comprises the steps of:
forming a three-dimensional surface representation of a surface part of the animal from the three-dimensional image recorded by the three-dimensional camera system,
determining a size parameter representative for the size of the animal on the basis of the surface representation, and
determining a volume parameter representative for the volume of the animal, and
monitoring the volume parameter and size parameter to monitor growth of the animal.

14. The monitoring device of claim 13, wherein the monitoring device, and in particular the processing device, is configured to perform:
recording, by a three-dimensional camera system, at least one three-dimensional image of the animal, and
processing, by the processing device, the at least one image of the animal,
wherein processing of the image comprises:
forming a three-dimensional surface representation of a surface part of the animal from the at least one image,
determining a size parameter representative for the size of the animal on the basis of the surface representation, and
determining a volume parameter representative for the volume of the animal, and
monitoring the volume parameter and size parameter or a combination thereof to monitor growth of the animal,
wherein determining a size parameter includes deters fining a number of size reference points in the three-dimensional surface representation and determining the size parameter on the basis of one or more distances between the size reference points and/or the height of these size reference points.

15. The monitoring device of claim 13, further comprising a weighing device arranged to determine a weight of the animal and to provide a weight value signal to the processing device.
